(19) United States
(12) Patent Application Publication
(10) Pub. No.: US 2017/0060891 A1
(43) Pub. Date: Mar. 2, 2017

(54) File-Type-Dependent Query System

(71) Applicant: Quixey, Inc., Mountain View, CA (US)

(72) Inventor: Jonathan BEN-TZUR, Sunnyvale, CA (US)

(21) Appl. No.: 14/836,893

(22) Filed: Aug. 26, 2015

(51) Int. Cl. G06F 17/30; G06F 3/0482; G06F 3/0484

(52) U.S. Cl. CPC G06F 17/30106; G06F 17/30554; G06F 3/04842; G06F 3/0482; G06F 17/30126

(57) ABSTRACT

A method of operating a device includes presenting a user interface for identification of a file and entering of a query by a user. The method includes determining type data indicating a file type of the identified file. The method includes creating a query wrapper based on the type data and the entered query and transmitting the query wrapper to a search system. A result set from the search system includes an identification of a first app state of a first app and a first access mechanism for the first app state. The method includes presenting the result set, including presenting a first user interface element corresponding to the first app state. The method includes, in response to actuation of the first user interface element, opening the first app to the first app state according to the first access mechanism and providing the identified file to the first app state.

### FIELD

The present disclosure relates to computer search systems and more particularly to computer search systems for app states.

### BACKGROUND

Applications can perform a variety of different actions for a user. As one example, a restaurant reservation application can make reservations for restaurants. As another example, an internet media player application can stream media (e.g., a song or movie) from the Internet. Some applications can perform more than one action. As one example, a restaurant reservation application may allow a user to retrieve information about a restaurant and read user reviews for the restaurant in addition to making restaurant reservations. As another example, an internet media player application may allow a user to perform searches for digital media and generate music playlists in addition to streaming media from the Internet.

An application state of an application may refer to a “screen” within the application. In general, an application state may refer to a configuration of an application in which the application displays content to the user, such as information related to one or more products, services, or vendors provided by, or accessible via, the application. An application state may also refer to a function provided by an application. As one example, an application state of an online shopping application may correspond to a screen of the application that describes (e.g., using text and/or image data) a particular product or service sold through the application (e.g., by one or more vendors associated with the application).

As another example, an application state of a music player application may correspond to a screen of the application that describes (e.g., using text and/or image data) a particular song that the application may play to a user (e.g., by displaying a name of the song, the album, and/or the musical artist).

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An apparatus includes a user interface module, a file type determination module, a query wrapper construction module, a network communication module, a result presentation module, and an access module. The user interface module is configured to allow a user to identify a file and to enter a query. The file type determination module is configured to determine type data for the identified file. The type data indicates a file type of the identified file. The query wrapper construction module is configured to create a query wrapper based on the type data and the entered query. The network communication module is configured to transmit the query wrapper to a search system and receive a result set from the search system. The result set includes (i) an identification of a first app state of a first app and (ii) a first access mechanism for the first app state. The result presentation module is configured to present the result set to the user, including presenting a first user interface element corresponding to the first app state. The access module is configured to, in response to actuation of the first user interface element by the user, (i) open the first app to the first app state according to the first access mechanism and (ii) provide the identified file to the first app state.

In other features, the type data includes one of (i) an Internet Assigned Numbers Authority media type and (ii) a MIME (Multipurpose Internet Mail Extensions) type. In other features, the file type determination module is configured to determine type data for the identified file based on at least one of an extension of the identified file and a header region of the identified file. In other features, the file type determination module is configured to set the type data for the identified file equal to an extension of the identified file.

In other features, the access module is configured to, in response to the first access mechanism being a web access mechanism, upload the identified file to a web server hosting the first app state. In other features, the access module is configured to, in response to the first access mechanism being a native access mechanism, provide a location reference of the identified file to the first app state. In other features, the apparatus includes a file management module configured to create a copy of the identified file prior to providing the identified file to the first app state. In other features, the file management module is configured to overwrite the identified file with the copy in response to an indication by the user that a modification made to the identified file was unwanted.

In other features, the result set includes (i) an identification of a second app state of a second app and (ii) a second access mechanism for the second app state. The access module is configured to, subsequent to modification of the identified file by the first app state and in response to actuation of a second user interface element by the user, (i) open the second app to the second app state according to the second access mechanism and (ii) provide the modified identified file to the second app state.

In other features, the user interface module is configured to, subsequent to the user exiting from the first app state after modifying the identified file, allow the user to enter a second query. The query wrapper construction module is configured to create a second query wrapper based on the type data and the second entered query. The network communication module is configured to transmit the second query wrapper to the search system and receive a second result set from the search system. The second result set includes (i) an identification of a second app state and (ii) a second access mechanism for the second app state. The second app state is from one of the first app and a second app. The result presentation module is configured to present the second result set to the user, including presenting a second user interface element corresponding to the second app state. The access module is configured to, in response to actuation of the second user interface element by the user, (i) open the one of the first app and the second app to the second app state according to the second access mechanism and (ii) provide the modified identified file to the second app state.

In other features, the apparatus includes an installed app data store that tracks apps installed on the apparatus. The query wrapper construction module is configured to include information from the installed app data store in the query wrapper. In other features, the apparatus includes an account data store that tracks active accounts registered with an operating system of the apparatus. The query wrapper construction module is configured to include information from the account data store in the query wrapper.

A method of operating a device includes presenting a user interface that provides for identification of a file and entering of a query by a user. The method includes determining type data for the identified file. The type data indicates a file type of the identified file. The method includes creating a query wrapper based on the type data and the entered query. The method includes transmitting the query wrapper to a search system. The method includes receiving a result set from the search system. The result set includes (i) an identification of a first app state of a first app and (ii) a first access mechanism for the first app state. The method includes presenting the result set to the user, including presenting a first user interface element corresponding to the first app state. The method includes, in response to actuation of the first user interface element by the user, (i) opening the first app to the first app state according to the first access mechanism and (ii) providing the identified file to the first app state.

In other features, the type data includes one of (i) an Internet Assigned Numbers Authority media type and (ii) a MIME (Multipurpose Internet Mail Extensions) type. In other features, the determining the type data is performed based on at least one of an extension of the identified file and a header region of the identified file. In other features, the determining the type data includes setting the type data based on an extension of a name of the identified file.

In other features, the providing the identified file to the first app state includes, in response to the first access mechanism being a web access mechanism, uploading the identified file to a web server hosting the first app state. In other features, the providing the identified file to the first app state includes, in response to the first access mechanism being a native access mechanism, providing a location reference of the identified file to the first app state. In other features, the method includes creating a copy of the identified file prior to providing the identified file to the first app state, and overwriting the identified file with the copy in response to an indication by the user that a modification made to the identified file was unwanted.

In other features, the result set includes (i) an identification of a second app state of a second app and (ii) a second access mechanism for the second app state. The method includes, subsequent to modification of the identified file by the first app state, presenting a second user interface element. The method includes, in response to actuation of the second user interface element by the user, (i) opening the second app to the second app state according to the second access mechanism and (ii) providing the modified identified file to the second app state.

In other features, the method includes, subsequent to the user exiting from the first app state after modifying the identified file, allowing the user to enter a second query. The method includes creating a second query wrapper based on the type data and the second entered query. The method includes transmitting the second query wrapper to the search system. The method includes receiving a second result set from the search system. The second result set includes (i) an identification of a second app state and (ii) a second access mechanism for the second app state. The second app state is from one of the first app and a second app. The method includes presenting the second result set to the user, including presenting a second user interface element corresponding to the second app state. The method includes, in response to actuation of the second user interface element by the user, (i) opening the one of the first app and the second app to the second app state according to the second access mechanism and (ii) providing the modified identified file to the second app state.

In other features, the method includes identifying apps installed on the device and identifying active accounts on the device. The query wrapper includes information based on the identified installed apps and the identified active accounts. In other features, a non-transitory computer-readable medium stores instructions that perform the above methods.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a combined functional block diagram and graphical user interface example according to the principles of the present disclosure.

FIGS. 2A-2H are example graphical user interfaces according to the principles of the present disclosure.

FIG. 3 is a high-level functional block diagram of the search system in an application ecosystem.

FIGS. 4A-4C are graphical depictions of example contents of query wrappers sent to a search system.

FIGS. 5A-5B are graphical depictions of example contents of results messages returned in response to a query wrapper.

FIG. 6 is a high-level block diagram of an example search system and representative data sources mined by the search system.

FIG. 7A is a graphical representation of an example app state record format.

FIG. 7B is a graphical representation of an example app state record according to the format of FIG. 7A.

FIG. 8 is a functional block diagram of an example implementation of a search app.

FIG. 9 is a functional block diagram of an example implementation of a search module of a search system.

FIG. 10 is a flowchart of example operation of a search app.

FIG. 11 is a flowchart of example operation of a search system.

In the drawings, reference numbers may be reused to identify similar and/or identical elements.

### DETAILED DESCRIPTION

When a user of a computing device (such as a smartphone) wants to perform an action using their device, they can search for apps capable of performing that action by using a search app. The user can inform the search app of what action is desired, and the search app will return a list of apps that may be able to perform that action. In fact, a search app may provide a specific state (or, screen) of an app that is dedicated to that action. In other words, for a user who is searching for cropping a picture, instead of simply returning an image editing app, the search app may return the state of the image editing app that is used for cropping a picture.

Especially for media files, such as images, the user may have a specific file in mind on which they would like to perform the action. According to the principles of the present disclosure, a file of interest can be specified within the search app. The search app determines what type the file is (for example, an image file may be a JPEG image), and the search app will identify apps and app states that support that file type.

In some implementations, the search app may return only apps that are definitively able to perform the desired action on the specified file type. In other implementations, the search app may simply exclude apps when it is clear that they do not support the file type for the desired action. Meanwhile, apps whose ability to support the file type is unclear may be de-emphasized (placed lower in a results list, shown smaller in size, etc.) than apps and app states that definitively do support that file type.

Once the user identifies the file of interest for the search app, when the user selects a search result, the search app may provide the file of interest to the selected app. The search app may have additional functionality, such as the ability to provide the file of interest to multiple ones of the search results. The search app may allow for essentially previewing the functionality of an app, preventing changes to the file of interest until the user indicates approval of the changes.

The search app may also support a series of actions. For example, a user may desire to remove red eye from an image and then upload the corrected image to “the cloud.” The search app may provide apps, and more particularly specific states of apps, for each of these actions. The search app may present app states for removing red eye first and, upon user approval of the red eye removal, present app states for image uploading. When the user selects one of the app states for image uploading, the search app provides the modified (red eye removed) image to the image uploading app state.

A sponsorship system may be integrated with the search system so that a developer can promote their app or even specific states of their app. Such a sponsor (also known as an advertiser) would be incentivized to ensure that the search system has a complete and accurate understanding of the file types supported in each state of the sponsor's app.

Sponsored apps and app states may be included in the search app results, and may be labeled as sponsored or may be included within organic (non-sponsored) results. In other implementations, sponsorship of an app or app state may simply emphasize an app or app state already included in the organic results. This emphasis may take the form of a visual enhancement, such as larger text, a larger tile size, or the addition of an image (for example, an app-specific image or a predefined image such as a star), or by moving the sponsored result higher in the results list. The sponsor may indicate that an app or app state will be sponsored only when certain keywords are present in the user's search query. Alternatively, the sponsor may desire to promote the app or app state any time the app or app state appears in the organic results.

The sponsor may commit to paying based on one or more of impressions (a user seeing the sponsored app), clicks (a user clicking, touching, or otherwise selecting the sponsored app being presented), cost per action (where the sponsor determines the action or engagement they are willing to pay for, such as a subsequent in-app purchase), and installs (when the sponsored app had not previously been installed and, as a result of the first app developer, the sponsored app being installed by a user). The sponsor may condition the payment—for example, only if the state is shown in a certain location, such as within a first screen of results.

A third party who is not a developer of an app may nonetheless desire to sponsor an app state. For example, an image cloud hosting service (such as the FLICKR social photography platform by Yahoo, Inc.) may correspond to a specific state of an image upload app. The image cloud hosting service may therefore sponsor app states that facilitate uploading images to their cloud platform.

In other features, the user may select another one of the search results, resulting in the user device launching the corresponding application, setting the application into the application state specified by the selected search result, and configuring the state to include the same specified file, in a similar manner as described above. In some examples, each displayed search result may indicate to the user (e.g., provide a description and/or a preview of) the function that the corresponding application state may perform with respect to the specified file upon the user selecting the search result.

By identifying application states of applications that both perform the function described by the user's search query and do so with respect to the file type of the file specified by the user, the techniques of this disclosure may enable generating search results that are more responsive to the user's search than search results generated using the search query alone. Additionally, by enabling the user to interact with multiple search results (e.g., to preview the corresponding application states, or to perform the functions provided by the states with respect to the specified file) without requiring the user to specify the file with respect for each search result (e.g., within each application state), the techniques may also simplify and improve the user's experience.

As a specific example, the user may enter a search query “upload image” and select an image file from a storage location on the user device. The user device may submit the search query, a file type of the image file, and other data associated with the user and/or the user device to the search system. The search system may identify application states of applications (e.g., social media applications) that enable users to upload images of the file type associated with the image file.

The search system may transmit search results that specify the application states to the user device. Upon the user selecting any of the search results, the user device may launch the corresponding application (e.g., the FLICKR social photography platform) and set the application into an application state specified by the selected search result. The user device may further configure the application state to include the image file. For example, the state may be configured to upload the image file immediately or after receiving user confirmation or additional user input.

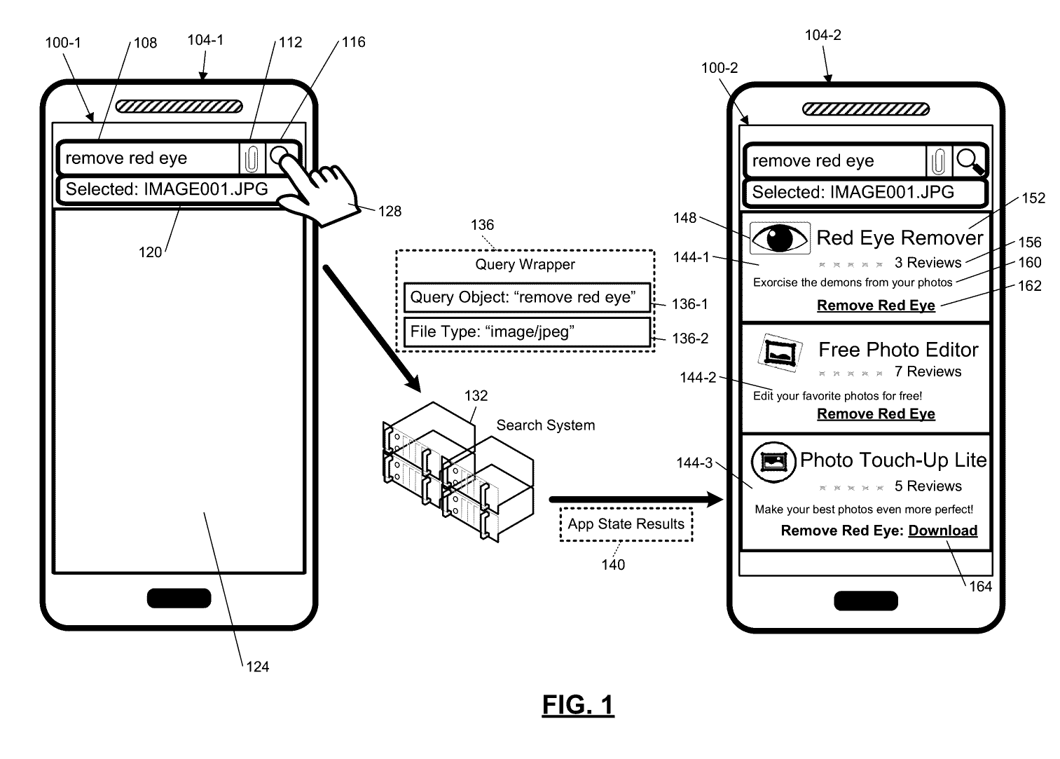

In FIG. 1, an unsophisticated search app 100 is shown running on a user device 104, such as a smartphone, tablet, or laptop. The user device 104 may be any suitable user computing device, such as a gaming device, a vehicle infotainment device, a wearable device, or a smart appliance (such as a smart refrigerator or smart television). A first view of the search app 100 is shown at 100-1 and the corresponding reference numeral for the user device 104 is 104-1. In addition, a second view 100-2 of the search app is shown within user device 104-2 and demonstrates example results of a performed search.

In the search app 100, a text box 108 allows the user to enter a search query. A user interface element 116 allows the user to specify a file of interest. For example only, the user interface element 116 may be a button with an icon of a paperclip, a widely recognized symbol for attachments.

A user interface element 116 may actuate a search based on the text box 108 and the file of interest. In various implementations, the user interface element 116 may be a button with text and/or an icon corresponding to search, such as a magnifying glass. A file display area 120 may indicate that a file has been selected and may include information about the file. In FIG. 1, the file name is shown, but other or additional information may be included, such as a source of the file (for example, a path or a source application), a determined file type of the file, a size of the file, a timestamp of the file (which may be modification, creation, or access), and/or a graphical preview of the file.

A results area 124 of the search app 100 may be empty prior to a search being performed. As shown in more detail below, the results area 124 may be used while specifying the file of interest. When the user actuates the user interface element 116 to perform a search, (indicated in FIG. 1 with hand 128, which is shown much smaller than actual scale to avoid obscuring the figure), the search app 100 communicates with a search system 132.

The search app 100 transmits a query wrapper 136 to the search system 132. A structure of the query wrapper 136 is discussed in more detail below. Two parameters of the query wrapper 136 are shown in FIG. 1, and include a query object 136-1 and a file type 136-2. The query object 136-1 may be a plaintext string—in this case, the user has entered “remove red eye” as the search query. The file type 136-2 is, in this example, a Multipurpose Internet Mail Extensions (MIME) type of “image/jpeg,” which is based on the file type of the file identified by the user (in this example, “IMAGE001.JPG”).

Although the term “MIME type” will be used in the disclosure for simplicity, MIME types are now officially known as media types and are listed by the Internet Assigned Numbers Authority (IANA). MIME types may also be referred to as content types. The present disclosure is not limited to using standardized MIME types, and may use any representation of file type as long as that representation is known both to the system that determines the file type from the file as well as the search system that tracks which file types are supported by each app and app state.

The search system 132 identifies app states that can perform red eye removal on JPEG file types and return app states results 140 to the search app 100. A display of example (and fictitious) results is shown in the second view 100-2 of the search app 100. In other words, the view 100-2 is from the same search app 100, and is simply later in time than the view 100-1. Similarly, the user device 104-2 is simply a view later in time of the user device 104 shown at 104-1.

Three results 144-1, 144-2, and 144-3 are shown. As an example, the result 144-1, for the “Remove Red Eye” state of the “Red Eye Remover” app includes an image 148 associated with the Red Eye Remover app, a title 152 of the Red Eye Remover app, and various other metadata. In this example, the metadata includes a rating and number of reviews 156 and a text description 160, which may be provided by the developer of the Red Eye Remover app.

Selecting the first result 144-1 may be accomplished by clicking a link 162 corresponding to the “Remove Red Eye” state of the Red Eye Remover app. Alternatively, clicking or touching anywhere within the first result 144-1 may cause the search app 100 to open the identified app and, if possible, navigate to a state of the results app that allows for red eye removal. The search app 100 may then indicate the file of interest (IMAGE001.JPG) to the resulting app state.

As seen in FIG. 1, the third result 144-3 includes a “Download” user interface element (such as a link or button) 164. This indicates that the app “Photo Touch-Up Lite” is not installed on the user device 104. By actuating the user interface element 164 (or, in some implementations, by clicking or touching anywhere within the third result 144-3), the search app 100 will access a digital distribution platform to allow the Photo Touch-Up Lite app to be downloaded and installed, after which the search app 100 will navigate to the appropriate state of the Photo Touch-Up Lite app and provide the file of interest.

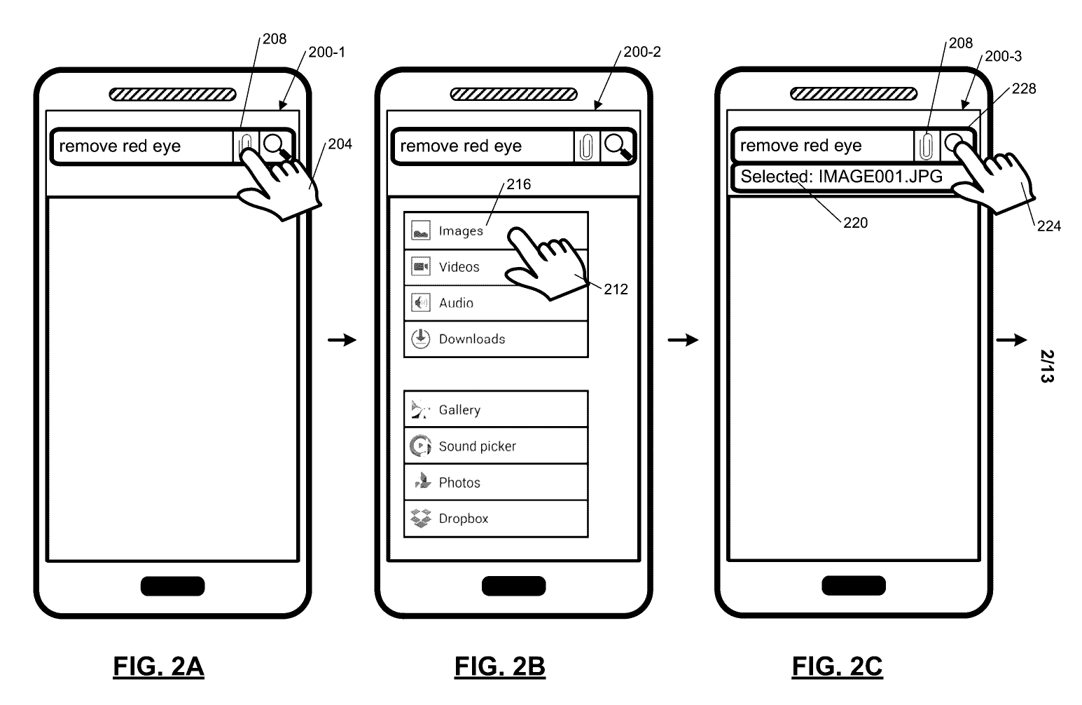

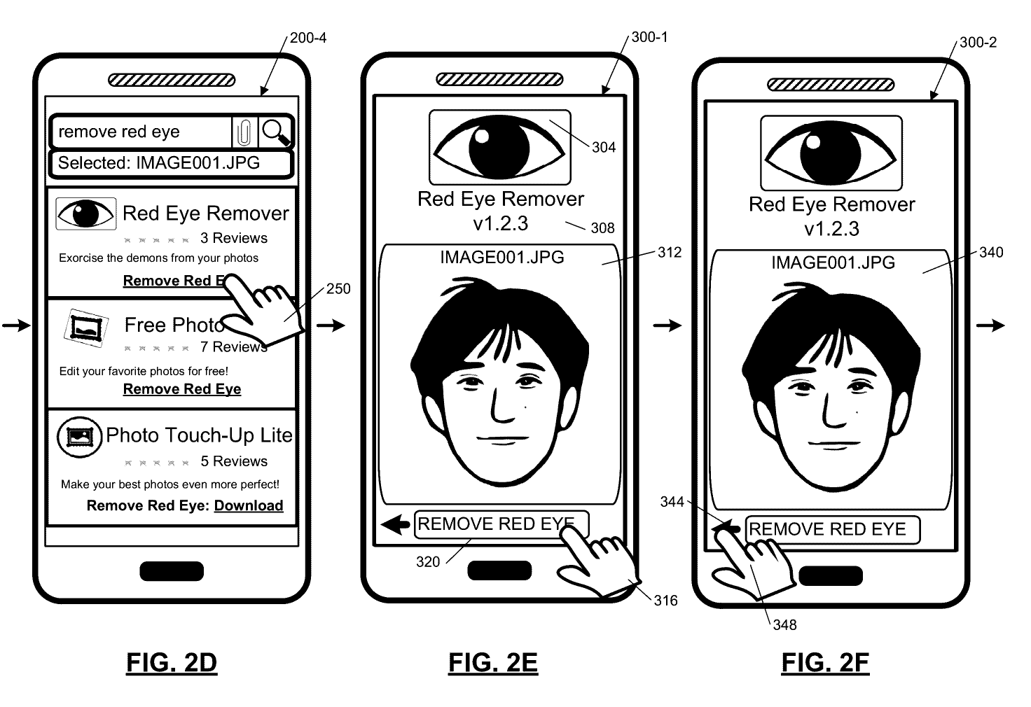

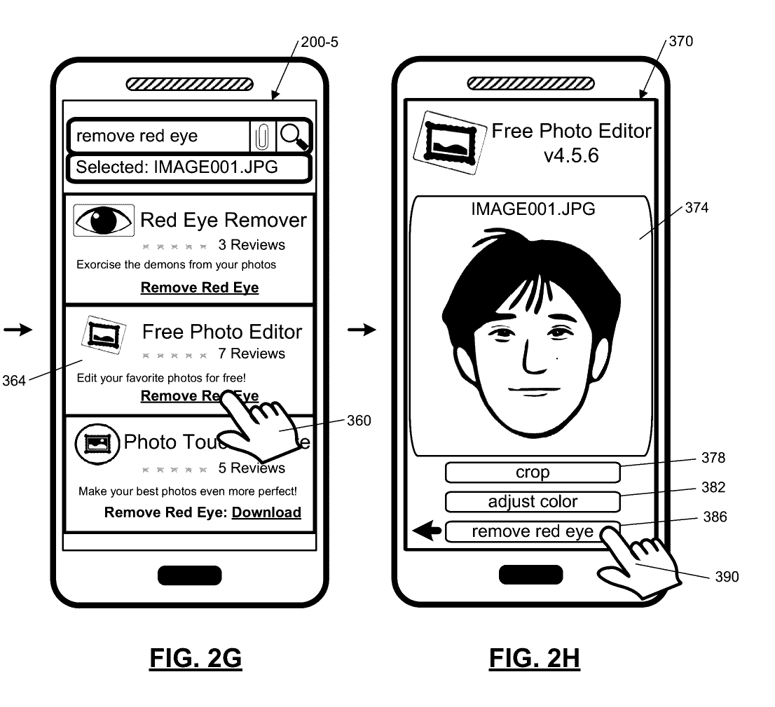

In FIGS. 2A-2H, various views of an example graphical user interface 200 begin in FIG. 2A at 200-1. As shown in FIG. 2A, the user has already typed (or entered by another mechanism, such as voice recognition) the search query “remove red eye.” A hand 204 (again, not drawn to scale) is shown actuating a user interface element 208 to specify a file for which red eye removal is desired.

Actuating the user interface element 208 leads to FIG. 2B. In view 200-2, a list of potential file sources is presented. The sources may include local repositories, which may vary based on user device operating system. For example, some operating systems include repositories or galleries dedicated to images, videos, and audio, and may also include locations, such as “Downloads.”

The search app 200 may also offer to specify a file from another app. The other app may be a built-in app, an app developed by the operating system developer, or a third party app. For example, a built-in gallery app or sound picker app may provide the file of interest. In other implementations, a photos app provided by the operating system developer may be offered. Local and/or cloud storage repositories may also be made available, such as the DROPBOX cloud storage and synchronization system or the MICROSOFT ONEDRIVE (not shown) cloud storage and synchronization system.

A hand 212 is shown selecting an images repository 216. The selection of an image from within the images repository 216 is not shown because the specific graphical user interface will vary from device to device. Once an image is selected from the images repository 216, view 200-3 of FIG. 2C is shown.

In FIG. 2C, the selected image (“IMAGE001.JPG”) is shown, such as in a non-editable textbox 220. In some implementations, the user interface element 208 for selecting a file may be hidden once the file is selected. Clicking or touching anywhere within the textbox 220 may re-open a file selection view, such as 200-2. A hand 224 is shown selecting a search user interface element 228.

When app state results are received, view 200-4 of FIG. 2D is shown. Similar to the view 100-2 of FIG. 1, three results are shown. A hand 250 illustrates a user selecting the app “Red Eye Remover” for a “Remove Red Eye” action. This causes the search app 200 to open the Red Eye Remover app to a state where removal of red eye is possible. Further, the search app 200 provides the identified image to the Red Eye Remover app.

In FIG. 2E, an example graphical user interface for the “Red Eye Remover” app is shown at 300-1. An icon 304 and title 308 form the branding (sometimes called chrome) of the Red Eye Remover app. A preview of the provided file (IMAGE001.JPG) is shown at 312. A hand 316 is shown actuating a “Remove Red Eye” button 320, which will instruct the Red Eye Remover app to remove red eye from the image.

In FIG. 2F, a view 300-2 of the app 300 includes a preview 340 of the image where, hopefully, any red eye effect has been removed. If the user is not satisfied with the red eye removal, the user may return to the search app 200, such as by actuating a back button 344. A hand 348 is shown in FIG. 2F actuating the back button 344, which leads to view 200-5 of the search app 200 in FIG. 2G. The back button 344 may be a built-in operating system soft button. In various implementations, such a button may only appear based on some user interaction that causes an operating system row of buttons to appear. For example only, this operating system row of buttons may include a back button, a home button, and a task switcher button.

In FIG. 2G, the view 200-5 of the search app 200 shows the same three results from FIG. 2D. Now, a hand 360 is shown selecting a “Free Photo Editor” app result 364. In various implementations, the view 200-5 may include a query to the user as to whether the operation performed on the specified file by the Red Eye Remover app should be accepted. For example, a dialog box may appear with choices of “yes” or “no” regarding whether the file modified by the Red Eye Remover app should be accepted. If the user indicates that the changes are not accepted, the specified file may be rolled back to its previous state (such as by restoring a back-up copy of the file). Alternatively, if the changes are accepted, the modified file may be provided to the Free Photo Editor app.

In FIG. 2H, an example user interface 370 of the Free Photo Editor app is shown. A preview 374 of the specified image is displayed, and image manipulation options are shown including crop 378, adjust color 382, and remove red eye 386. A hand 390 is shown selecting remove red eye 386. This will cause the Free Photo Editor app to attempt to remove red eye and potentially to update the preview 374. The user may then save the modified image using a feature (not shown) within the Free Photo Editor, may save the modification by returning to the search app 200, or the changes may automatically be saved unless explicit action is taken to reject the changes.

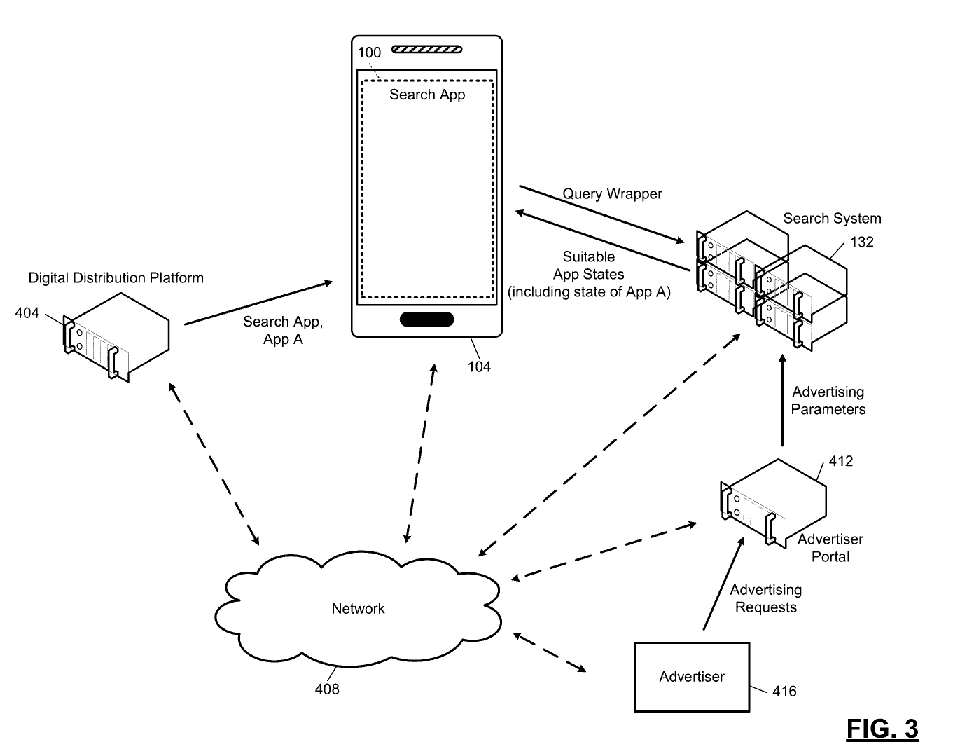

As seen in FIG. 3, the user device 104 may receive the search app 100 from a digital distribution platform 404. The digital distribution platform 404 may provide native applications to user devices. Example digital distribution platforms include the GOOGLE PLAY digital distribution platform by Google, Inc., the APP STORE digital distribution platform by Apple, Inc., and the WINDOWS PHONE digital distribution platform by Microsoft Corp.

While FIG. 3 shows the search app 100 being provided to the user device 104 from the digital distribution platform 404, the communication may actually be carried over a network 408, as indicated by dashed lines. The network 408 may encompass local area networks, mobile phone provider networks, and a distributed communications network, such as the Internet.

The search app 100 communicates with the search system 132 via the network 408. Specifically, a query wrapper, as discussed in more detail below, may include a text query as well as an indication of file type, and is transmitted from the search app 100 to the search system 132. The search system 132 generates results, which may include apps as well as states of apps. The search system 132 provides suitable apps and app states back to the search app 100.

As an example, the suitable app states may include a state of an app identified as “App A”. If the user device 104 selects the state corresponding to App A, and App A is not yet installed, the user device 104 may retrieve App A from the digital distribution platform 404. The search system 132 may adapt the app state results based on advertising parameters from an advertiser portal 412. The advertiser portal 412 may allow an advertiser 416 to make advertising requests, such as to promote an app or app state. The advertiser portal 412 may also allow the advertiser 416 to specify keywords, bid prices, and other advertisement parameters.

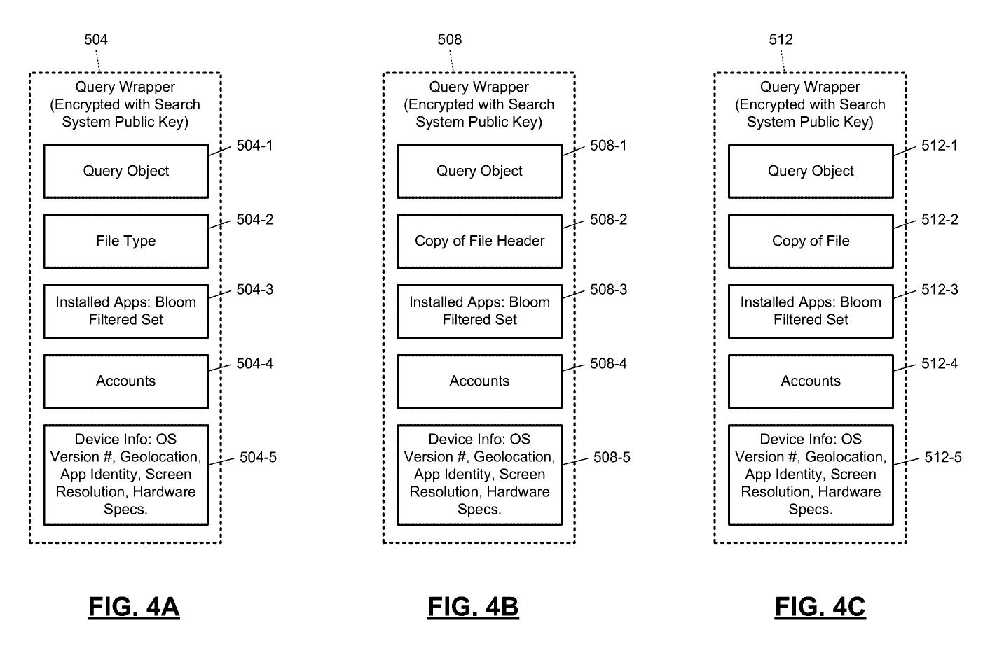

In FIG. 4A, an example query wrapper 504 can be, in various implementations, encrypted with a public key of the search system 132. This public key may be embedded in the search app 100 and its use prevents any eavesdropper from inspecting or modifying the query wrapper 504. Only the search system 132 has the corresponding private key.

The query wrapper 504 includes a query object 504-1, which may be a plaintext string entered by a user. A file type 504-2 indicates the file type of the file specified by the user and may be a string storing the name of a MIME type. Alternatively, the file type 504-2 may be a shortened representation pre-arranged between the search app 100 and the search system 132. In other implementations, the file type 504-2 may be a text string of the extension of the file name of interest.

A representation of installed apps 504-3 may be included. For example, an exhaustive listing of all installed apps (which may be specified by title or a unique identifier and may include version number) may be included. In other implementations, a bit field may be specified for a set of the most popular apps. In one example, 100 binary digits correspond to whether each of the 100 most popular apps are installed. The 100 most popular apps must be known to both the search app 100 and the search system 132. If the most popular apps change over time, the search system 132 will need to alert the search app 100 so that the bit field is interpreted correctly. Although 100 is used as an example, a power of two (such as 128) may be used for greater storage efficiency.

Another mechanism for indicating installed apps using a limited amount of data is a Bloom Filter. The Bloom Filter specifies whether an app from a pre-defined set of apps is potentially installed on the device or whether the app is definitely not installed. To achieve reduced storage space, the output of a Bloom Filter does not definitively state whether a certain app is present; only whether an app is definitively not present.

An accounts structure 504-4 indicates which accounts are present on the user device, and any relevant details about those accounts, such as whether the account is active. This may impact how relevant an app state is, and therefore its place or even presence in the search results rankings. For example, if the user has an active account with the ADOBE CREATIVE CLOUD content creation service, app states corresponding to the ADOBE CREATIVE SUITE may be prioritized, and vice versa. A device information data structure 504-5 may encode the operating system identity and version number, geolocation data of the user device, screen resolution, orientation (portrait or landscape), and sensor capability (such as precision of accelerometer or presence of heart rate sensor).

In FIG. 4B, a query wrapper 508 may be similar to the query wrapper 504, except that instead of a file type, the query wrapper 508 includes a copy of a portion of the specified file, such as a copy of the file header 508-2. The copy of the file header 508-2 may be sent to allow the search system 132 to make a determination about the file type. In other implementations, the file header may be sent only when the search app 100 is unable to determine the file type.

In FIG. 4C, a query wrapper 512 is similar to the query wrappers 504 and 508, but a copy of the entire file is included at 512-2. A copy of the entire file 512-2 may be included to allow the search system 132 to make its own determination of the file type. When sending the copy of the file header 508-2 or the copy of the entire file 512-2, in some implementations the search app 100 may omit any independent file type determination logic.

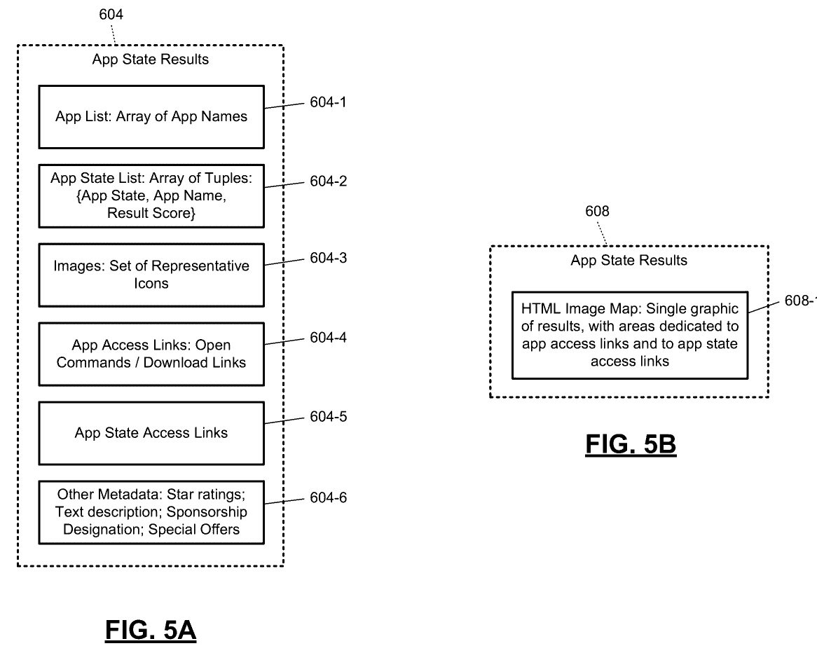

In FIG. 5A, an app state results structure 604 includes an app list 604-1. For example, the app list 604-1 may include an array of strings, each string storing an app name. The array may generally be ordered from most relevant to least relevant, though the order may be adjusted based on sponsorship. The number of apps provided in the app list 604-1 may be chosen according to a resolution of the device sending the query wrapper. For example, a device with a larger screen and/or higher resolution may receive a larger number of apps. r

An app state list 604-2 includes an array of pairs, where a first value of each pair corresponds to an app state (which may be a title, such as “remove red eye”) and the second value of each pair corresponds to the associated app (such as the “Red Eye Remover” app).

An images field 604-3 may include images, such as icons, for each of the apps in the app list 604-1. In other implementations, the images field 604-3 may include images, such as screenshots, for each of the app states in the app state list 604-2.

An app access links field 604-4 specifies access mechanisms for a default state of each of the apps in the app list 604-1. For example, the access links may include commands to open the app if the app is installed and/or links to a digital distribution platform to download an app that is not installed. Another access mechanism may be a URL (uniform resource locator) to access a web-based app through a browser. When the app state results structure 604 is returned, code within the app may determine whether open versus download is the appropriate action based on the specific installation status of each app.

An app state access links field 604-5 specifies access mechanisms for each of the app states in the app state list 604-2. As described below, an access mechanism may include a link to a web page or an application programming interface call to open an app directly to a state. The access mechanism may instead include a script to open an app and navigate to the specific state. An access mechanism may also include instructions (such as in a script) to download and install an app from a digital distribution platform before opening the app.

Additional metadata 604-6 may include a rating for each app (such as a number of stars), a text description for each app, review text and metrics (such as number of reviews), and a designation of sponsorship. The sponsorship designation may be a simple binary flag or may include an indication of sponsorship level. For example, a sponsor may be willing to pay a greater amount for a new install than for usage of an existing app. This level of interest by the sponsor may allow the search app to promote the sponsored app more prominently in hopes of recognizing that revenue.

The additional metadata 604-6 may include download velocity or other indicators of trending popularity of an app. A new and valuable app may not yet have a large installed base, but may show rapid growth in number of downloads. Therefore, trending popularity may be used as a signal to rank the display of apps, with trending apps moved higher up in a results list. Further, a visual indication of trending, such as text (“trending” or a word correlated with trending, such as “popular”) or an icon, may be shown in close proximity to an app for which a trending metric of the app is above a threshold. The threshold may be an absolute threshold for all apps, or may be relative/normalized to the market segment in which the app exists or to the other apps in the results list.

In FIG. 5B, app state results 608 may include an HTML (hypertext markup language) image map 608-1. The HTML image map 608-1 may be a single image, such as a JPEG (joint photographic experts group) or PNG (portable network graphics) image, divided into separate areas. Each area corresponds to an app or app state and shows text and/or icons corresponding to that app or app state. When the HTML image map is actuated, the corresponding section of the image map activates a corresponding access mechanism for the app or state displayed in that region of the HTML image map 608-1.

The HTML image map 608-1 may be sized by the search system 132 according to the size of the requesting device. In other implementations, the search system 132 may provide HTML image maps of varying sizes and an appropriate one may be selected at the user device according to the resolution of the device's screen and the amount of real estate to be dedicated to the results display. The search system 132 may create an HTML image map that will work with a certain range of display sizes and resolutions, and if the specified region for display is within that certain range, the HTML image map may be proportionally scaled by the device.

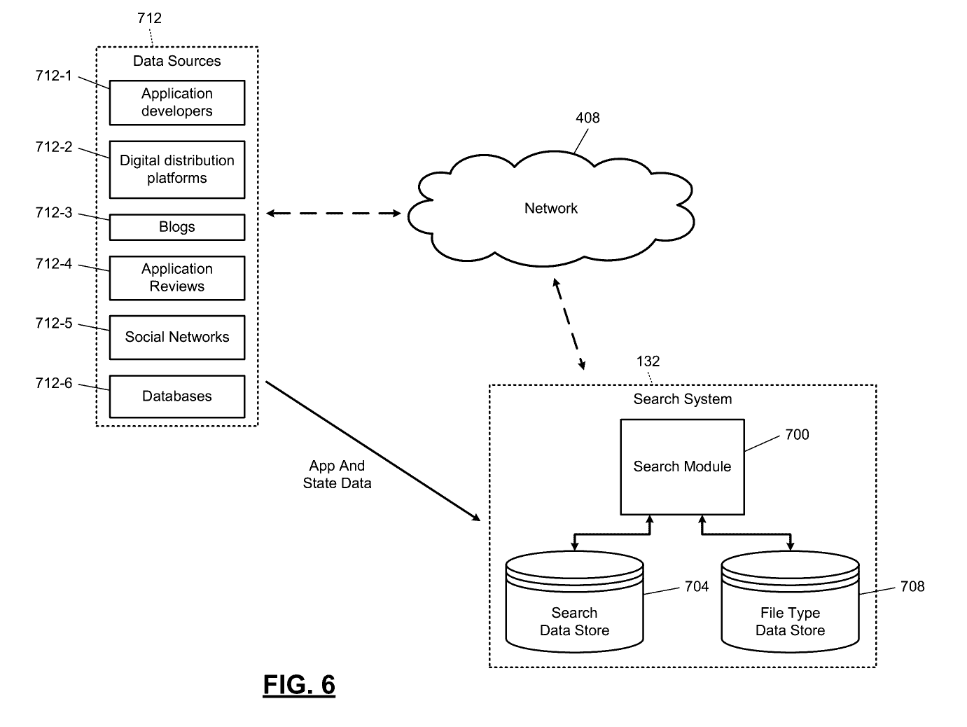

FIG. 6 illustrates an example environment of the search system 132. The search system 132 is a collection of computing devices that receives search queries from user devices via the network 408. In some implementations, user devices communicate with the search system 132 via a partner computing system (not illustrated). The partner computing system may be a computing system of a third party that leverages the search functionality of the search system 132.

The partner computing system may be owned by a company or organization other than the operator of the search system 132. Examples of such third parties include Internet service providers, aggregated search portals, and mobile phone providers. The user devices may send search queries to the search system 132 and receive search results from the search system 132, all via the partner computing system. The partner computing system may provide a customized user interface to the user devices and/or may modify the search experience provided on the user devices.

The example implementation of the search system 132 shown in FIG. 6 includes a search module 700, which references app state data stored in a search data store 704 and file type data stored in a file type data store 708. The data in the search data store 704 and the file type data store 708 may be obtained from data sources 712. The search data store 704 and the file type data store 708 may be maintained and updated by the search module 700 and/or a maintenance component (not shown) of the search system 132.

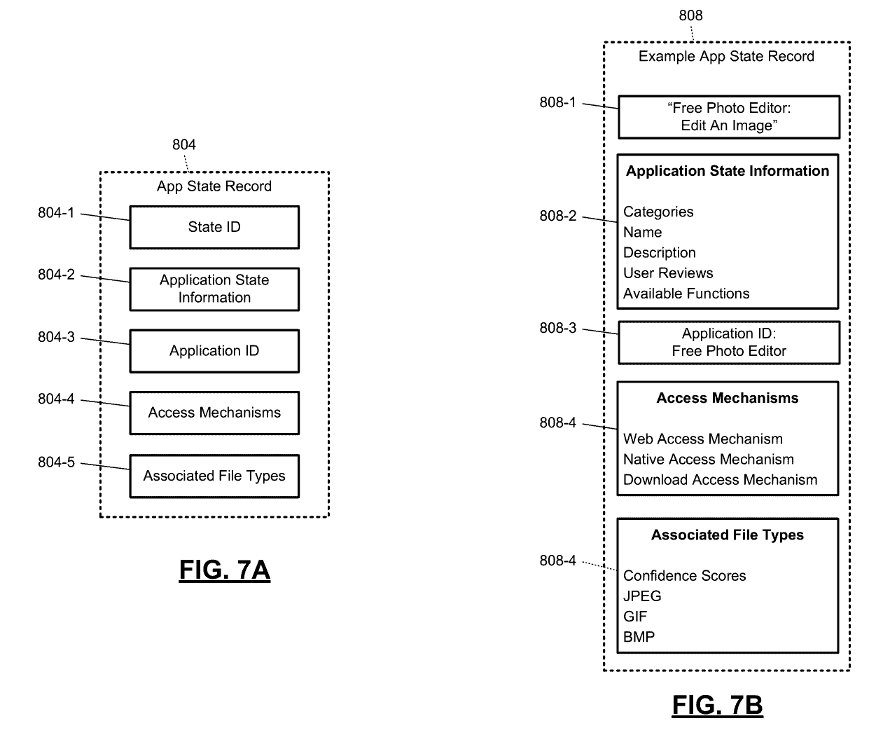

The search data store 704 and the file type data store 708 may be updated with databases, indices, tables, files, and other data structures, which may be populated from the data sources 712. The search data store 704 may store app state records, which may be in the format shown in FIG. 7A.

Parsers and other ETL (extract, transform, and load) processes may adapt data from the data sources 712 for storage in the search data store 704. In some implementations, data may be manually entered and/or manually transformed into a format usable by the search data store 704. The data sources 712 may include data 712-1 from application developers, such as application developers' websites and data feeds provided by developers.

The data sources 712 may include digital distribution platforms 712-2, accessed via the web or via an app. The data sources 712 may also include other websites, such as blogs 712-3, application review websites 712-4, and social networking sites 712-5, such as the FACEBOOK application and website by Facebook, Inc. and the TWITTER application and website by Twitter, Inc.

The data sources 712 may also include online databases 712-6 of data related to movies, television programs, music, restaurants, etc. Each of the data sources 712 may have independent ontologies and may be updated at different rates. Therefore, the search data store 704 may be updated from each of the data sources 712 at different rates. In addition, credibility and accuracy of data may differ across the data sources 712. Measures of reliability, timeliness, and accuracy may be stored in the search data store 704 and may be used to weight search results obtained from those data sources 712.

As described above, the search system 132 generates search results based on a search query and an indication of a file type received from a user device, and based on the data included in the search data store. Specifically, the search module 700 identifies one or more app state records included in the search data store 704 based on the search query and the file type indication. The search module 700 uses one or more app state IDs that identify the identified app state records to select one or more access mechanisms from the identified records and transmits the selected access mechanisms to the user device as search results. In some examples, the search module 700 receives the indication of the file type from the user device and identifies the app state records based on the indication.

The search data store 704 includes information for each app and/or for each app state regarding the supported file types for that app or app state. For a given app state, the search data store 704 may store a list of file types that are definitely supported, a list of types that are definitely not supported, a list of file types that may be supported, etc. In one example, the search data store 704 may include an array of file type tuples. Each tuple may include a MIME type and a confidence value. The confidence value may indicate how confident the search system 132 is regarding the ability of the app state to process that file type.

In one implementation, a confidence value of 1 indicates absolute confidence that the app state can handle that file type. A confidence value of −1 indicates absolute confidence that the app state cannot handle that file type. A confidence value of 0 may indicate that there is no data regarding whether the app state can handle that file type.

Various compression schemes may be used to reduce the amount of storage required to store this array of tuples for each app state. For example, many image programs may be able to handle a certain set of image types. This set of image types may be identified as a group type. Then an app state only needs to add a tuple specifying that group and a confidence value in order to refer to every file type within the group. Further, for a given app state, file types for which there is little to no information (which may correspond to a confidence value of approximately 0) may not be stored at all.

The file types able to be handled by app states may be determined, in various implementations, by consulting a manifest file for the app. The manifest file may specify which file types are handled by the app. In the absence of other information, it may be assumed that each action performed by the app can therefore handle those file types. In other implementations, the manifest file may specify supported file types on a per-state basis.

An example of a data tag in a manifest file is “android:mimetype=image/jpeg”, which indicates that the app supports jpeg images. When a manifest file does list supported file types, an inference may be made that any non-listed file types are not supported. This may be reflected in the data for the app state by specifying that “all other types” have a confidence value of −1.

Another example data tag from a manifest file is “android:mimetype=image/*”, which conveys that the application accepts all image types. The search data store 704 may define a group that includes all image types of interest to the search system 132. The corresponding app state of this app therefore has a tuple corresponding to the group of all images and a confidence value of 1 (or less than 1). The confidence value may be less than 1 because it is quite likely that an app purporting to accept all image types will be unable to handle every rare image type.

Feedback, such as from users, operators of the search system 132, and application feedback (such as crash reports from apps unable to process certain file types), may be used to update the app state records in the search data store 704. For example, an app that purports to accept all image types may be determined to be unable to handle a certain image type (such as PGF, or progressive graphics file). As a result, another tuple will be added to the app or app state to indicate a negative confidence value for that file type. For this reason, when parsing file type tuples for an app state, the search system 132 may look at more specific tuples, such as those tuples directed to a single file type, as being controlling over more general tuples, such as those that apply to a group of image types.

In FIG. 7A, an example format of an app state record 804 includes a state identifier (ID) 804-1, app state information 804-2, an application identifier (ID) 804-3, one or more access mechanisms 804-4 used to access the application state, and associated file types 804-5 handled by the application state.

The state ID 804-1 may be used to uniquely identify the app state record 804 among the other app state records included in the search data store 704. In some examples, the state ID 804-1 describes a function and/or an application state in human-readable form. For example, the state ID 804-1 may include the name of the application referenced in the access mechanisms 804-4.

In a specific example, a state ID 804-1 for an Internet music player application may include the name of the Internet music player application along with the song name that will be played when the Internet music player application is set into the state defined by the access mechanism 804-4 included in the app state record 804. In some examples, the state ID 804-1 includes a string formatted similarly to a uniform resource locator (URL), which may include an identifier for the application and an identifier of the state within the application. In other implementations, a URL used as the state ID 804-1 may include an identifier for the application, an identifier of a function to be provided by the application, and an identifier of an entity that is the target of the function.

The app state information 804-2 may include data that describes an application state into which an application is set according to the access mechanisms 804-4 in the app state record 804. The types of data included in the app state information 804-2 may depend on the type of information associated with the application state and the functionality specified by the access mechanisms 804-4. The app state information 804-2 may include a variety of different types of data, such as structured, semi-structured, and unstructured data. The app state information 804-2 may be automatically and/or manually generated and updated based on documents retrieved from the data sources 712.

In some examples, the app state information 804-2 includes data presented to a user by an application when in the application state corresponding to the app state record 804. For example, if the app state record 804 is associated with a music player application, the app state information 804-2 may include data that describes a song (e.g., name and artist) that is displayed and/or played when the music player application is set to the specified application state.

When the app state record 804 corresponds to a default state of an application, the app state information 804-2 may include information generally relevant to the application and not to any particular application state. For example, the app state information 804-2 may include the name of the developer of the application, the publisher of the application, a category (e.g., genre) of the application, a text description of the application (which may be specified by the application's developer), and the price of the application.

The app state information 804-2 may also include security or privacy data about the application, battery usage of the application, and bandwidth usage of the application. The app state information 804-2 may also include application statistics, such as number of downloads, download rate (for example, average downloads per month), download velocity (for example, number of downloads within the past month as a percentage of all-time downloads of the app), number of ratings, and number of reviews.

The application ID 804-3 uniquely identifies an application associated with the app state record 804. The access mechanisms 804-4 specify one or more ways that the state specified by the app state record 804 can be accessed. For any given user device, only some of the access mechanisms 804-4 may be relevant.

For illustration, in FIG. 7B an example app state record 808 includes a state ID 808-1 in the form of human-readable text: “Free Photo Editor: Edit An Image”. The example app state record includes application state information 808-2, including app category, state name, text description, user reviews (numerical and/or text), and available functions. For example, the available functions for this state may include cropping the image, rotating the image, and removing red eye.

An application ID 808-3 uniquely identifies the Free Photo Editor app. The application ID 808-3 may refer to a canonical Free Photo Editor software product that encompasses all of the editions of the Free Photo Editor application, including all the native versions of the Free Photo Editor application across platforms (for example, the IOS operating system and the ANDROID operating system) and any web editions of the Free Photo Editor application.

There are three access mechanisms 808-4 shown: a web access mechanism, a native app access mechanism, and a native download access mechanism. The web access mechanism may take the form of a URL (uniform resource locator) that corresponds to a web page for “Edit An Image” on the Free Photo Editor website.

The native access mechanism may include an application resource identifier for the native edition of the Free Photo Editor app on a particular operating system and one or more operations that navigate to the state in the Free Photo Editor app for the Edit An Image state. In various implementations, and for various app states, an access mechanism may be able to directly access the state (such as by using an ANDROID operating system intent). If the Free Photo Editor: Edit An Image app state is available on multiple operating system platforms, there would generally be multiple native access mechanisms.

The download access mechanism may include instructions to open a portal to a digital distribution platform to download and install the app, followed by opening the app and navigating to the correct state, where the opening and the navigating may be the same as the native access mechanism. In other words, the actions taken by the download access mechanism may be a superset of those of the native access mechanism.

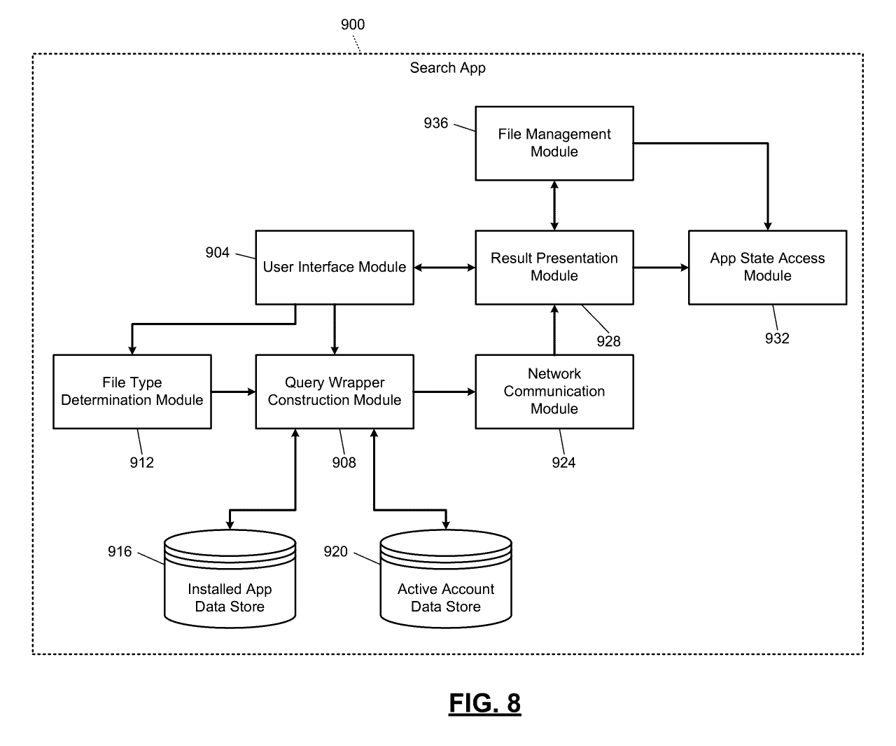

In FIG. 8, a functional block diagram of an example implementation of a search app 900 includes a user interface module 904. The user interface module 904 allows a user to specify a query, which is sent to a query wrapper construction module 908.

The user interface module 904 also permits the user to identify a file of interest. The file of interest is provided to a file type determination module 912, which determines the type of the file and provides that file type to the query wrapper construction module 908. The file type determination module 912 may determine the type of the file based on an extension in the name of the file, based on metadata in the header of the file, based on an analysis of the structure of the header and/or body of the file, and/or from an indication from the operating system.

The query wrapper construction module 908 may also receive data from an installed app data store 916 and an active account data store 920. The installed app data store 916 may be populated from information provided by the operating system regarding which apps are installed. In other implementations, the operating system may simply be queried on demand by the query wrapper construction module 908 to determine what apps are installed.

The active account data store 920 tracks which accounts on the user device are active. This tracking may be based on information provided by the operating system and may require special permissions. The query wrapper construction module 908 constructs a query wrapper including the text query from the user and the file type from the file type determination module 912.

When the user's intent to search is identified, such as by the user clicking or tapping a search icon, the query wrapper construction module 908 provides the query wrapper to a network communication module 924 for transmission to the search system 132 over a network, such as the network 408. In other implementations, the query wrapper may be sent even before a user request so that results can be rendered instantaneously if the user does make the search request.

The network communication module 924 receives results from the search system 132 and provides those results to a result presentation module 928. The result presentation module 928 presents the results to the user via the user interface module 904. In response to user selection of one of the results, the result presentation module 928 passes corresponding access mechanism information to an app state access module 932.

As described in more detail below, the app state access module 932 navigates to the specified app state of the specified app. Meanwhile a file management module 936 downloads or otherwise acquires a copy of the file of interest. The file management module 936 may make a backup copy in case changes are desired to be reverted and/or may make a temporary copy for use by the app. The file management module 936 passes identifying information (such as a pointer or link) about the file of interest, or a temporary version of the file of interest, to the app state access module 932. The app state access module 932 provides the identification of the file of interest to the app state to allow the file of interest to be operated on by the app state.

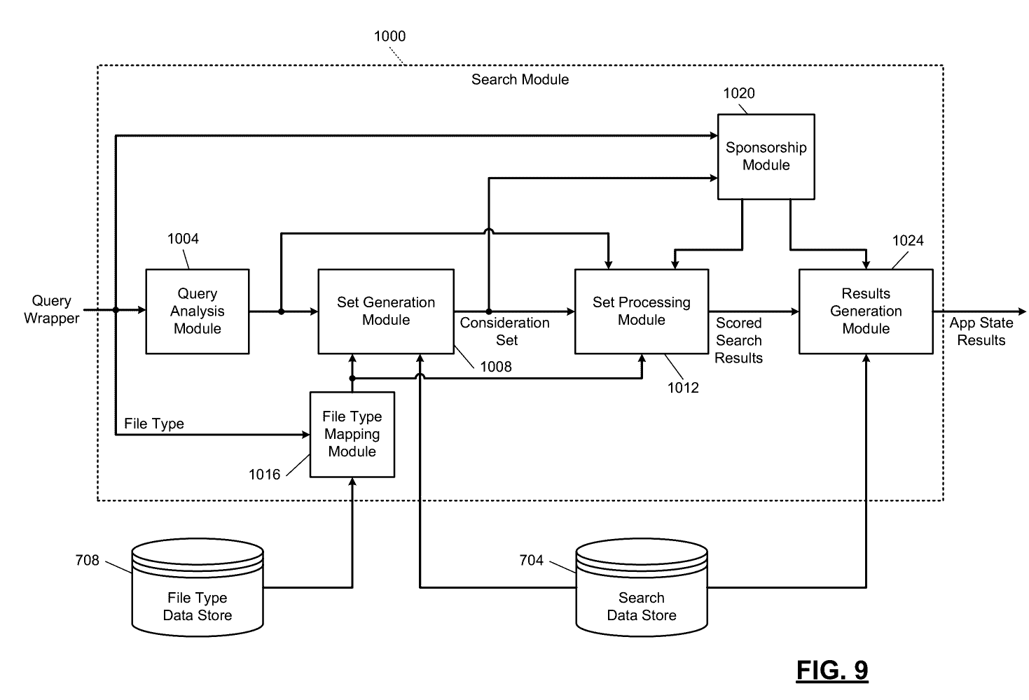

In FIG. 9, a functional block diagram of an example implementation of a search module 1000 includes a query analysis module 1004 that receives the query wrapper. The query analysis module 1004 analyzes the text query from the query wrapper. For example, the query analysis module 1004 may tokenize the query text, filter the query text, perform word stemming, synonymization, and stop word removal. The query analysis module 1004 may also analyze additional data stored within the query wrapper. The query analysis module 1004 provides the tokenized query to a set generation module 1008.

The set generation module 1008 identifies a consideration set of application and app state records based on the query tokens. Some or all of the contents of the records of the search data store 704 may be indexed in inverted indices. In some implementations, the set generation module 1008 uses the APACHE LUCENE software library by the Apache Software Foundation to identify records from the inverted indices.

The set generation module 1008 may search the inverted indices to identify records containing one or more query tokens. As the set generation module 1008 identifies matching records, the set generation module 1008 can include the unique ID of each identified record in the consideration set. For example, the set generation module 1008 may compare query terms to the application name and application attributes (such as a text description and user reviews) of an app state record. The set generation module 1008 may also compare the query terms to application state information (such as application name and description and user reviews) of an app state record.

Further, in some implementations, the set generation module 1008 may determine an initial score of the record with respect to the search query. The initial score may indicate how well the contents of the record matched the query. For example, the initial score may be a function of the term frequency-inverse document frequency (TF-IDF) values of the respective query terms.

A set processing module 1012 receives the unique IDs from the set generation module 1008 and determines a result score for some or all of the IDs. A result score indicates the relevance of an application or app state, given the tokenized query and context parameters, with a higher score indicating a greater perceived relevance. For example, other items in the query wrapper may act as context parameters. Geolocation data may limit the score of (or simply remove altogether) apps that are not pertinent to the location of the user device.

The set processing module 1012 may generate a result score based on one or more scoring features, such as record scoring features, query scoring features, and record-query scoring features. Example record scoring features may be based on measurements associated with the record, such as how often the record is retrieved during searches and how often links generated based on the record are selected by a user. Query scoring features may include, but are not limited to, the number of words in the search query, the popularity of the search query, and the expected frequency of the words in the search query. Record-query scoring features may include parameters that indicate how well the terms of the search query match the terms of the record indicated by the corresponding ID.

The set processing module 1012 may include one or more machine-learned models (such as a supervised learning model) configured to receive one or more scoring features. The one or more machine-learned models may generate result scores based on at least one of the app state ID scoring features, the record scoring features, the query scoring features, and the record-query scoring features.

For example, the set processing module 1012 may pair the search query with each ID and calculate a vector of features for each {query, ID} pair. The vector of features may include one or more record scoring features, one or more query scoring features, and one or more record-query scoring features. In some implementations, the set processing module 1012 normalizes the scoring features in the feature vector. The set processing module 1012 can set non-pertinent features to a null value or zero.

The set processing module 1012 may then input the feature vector for one of the application or app state IDs into a machine-learned regression model to calculate a result score for the ID. In some examples, the machine-learned regression model may include a set of decision trees (such as gradient-boosted decision trees). Additionally or alternatively, the machine-learned regression model may include a logistic probability formula. In some implementations, the machine-learned task can be framed as a semi-supervised learning task, where a minority of the training data is labeled with human-curated scores and the rest are used without human labels.

The machine-learned model outputs a result score of the ID. The set processing module 1012 can calculate result scores for each of the IDs that the set processing module 1012 receives. The set processing module 1012 associates the result scores with the respective IDs and outputs the most relevant scored IDs.

A file type mapping module 1016 receives the file type designated in the query wrapper. The file type mapping module 1016 maps the file type contained in the query wrapper to an internal representation of file types for use by the set generation module 1008. Information for the mapping is stored in the file type data store 708. For example only, the file type from the query wrapper may be a MIME type, while the file types specified in the search data store 704 may be hexadecimal numbers proprietary to the search data store 704.

Further, an incoming file type may map to multiple internal (that is, internal to the search data store 704) file types, such as when an incoming file type of image/jpeg maps to jpg, jpe, and jpeg. In other implementations, the reverse mapping may be present. For example, the file type received from the query wrapper may simply be a plaintext string of the file's extension. File type mapping module 1016 may therefore map the extension onto a file type consistent with the search data store 704. For example, “jpeg”, “jpg”, “jpeg”, and “jp2” extensions may all map to the same image/jpeg type recognized by the search data store 704.

The mapped file types are provided to the set generation module 1008 and/or the set processing module 1012. The set generation module 1008 may filter app states based on the mapped filed types, as described in more detail below, before beginning to produce the consideration set. The set processing module 1012 uses the mapped files types to score the app states in the consideration set.

A sponsorship module 1020 receives the query wrapper and identifies apps and app states relevant to the query for which sponsorship has been indicated by an advertiser. For example, the sponsorship module 1020 may receive the consideration set from the set generation module 1008 and identify apps and app states within the consideration set for which sponsorship is desired. For example, the apps and/or app states in the consideration set that have corresponding sponsorship bids may be ranked. Those apps or app states with the highest initial score may be selected as sponsored links and provided to the set processing module 1012 for inclusion in the search results.

The set processing module 1012 may score the IDs provided by the sponsorship module 1020, and if the result score is high enough, output the sponsored apps or app states as part of the ordered search results. In other implementations, the sponsorship module 1020 may supply a tag with one or more of the IDs instructing the set processing module 1012 to include the IDs as sponsored results regardless of their result score.

The sponsorship module 1020 may operate according to a variety of targeting parameters, which may be specified by an advertiser, such as by using the advertiser portal 412. For example, the advertiser may desire to have their app shown when similar apps are included in the consideration set. The similarity may be explicitly specified by the advertiser—for example, by listing apps similar to the advertiser's app. In other implementations, the search system 132 may include a similarity assessment module (not shown) that assesses how similar two apps are to each other. The similarity assessment module may determine the similarity between each of the apps in the consideration set with each of the potential sponsored apps. In various implementations, the advertiser may choose to have their app shown when the search query includes certain keywords or file types.

The sponsorship module 1020 may take into account whether a sponsored app is already installed on the user device from which the query wrapper was received. An advertiser may only be willing to pay a reduced price (or even nothing) to promote their app if their app is already installed on the user device.

The sponsorship module 1020 may select sponsored apps based on bid prices set by advertisers. An advertiser may set different bid prices to promote their app based on, for example, whether their app is already installed, how similar their app is to other apps in the result set, etc. The sponsorship module 1020 may choose, for inclusion in the ordered search results, apps having the highest bid prices for the present search.

A results generation module 1024 may choose specific access mechanisms from the application records and app state records selected by the set processing module 1012. The results generation module 1024 then prepares a results set to return to the user device. Although named “app state results,” some of the access mechanisms may be to a default state (such as a home page) of an app—these may be special cases of an app state record or simply an application record.

The results generation module 1024 may choose access mechanisms based on the operating system identity and version for the user device to which the results are being transmitted. For example, a script to download, install, open, and navigate to a designated state may be fully formed for a specific operating system by the results generation module 1024.

If the results generation module 1024 determines that none of the native access mechanisms are likely to be compatible with the user device, the search module 1000 may send a web access mechanism to the user device. If no web access mechanism is available, or would be incompatible with the user device for some reason (for example, if the web access mechanism relies on a JAVA programming language interpreter that is not installed on the user device), the results generation module 1024 may omit the result.

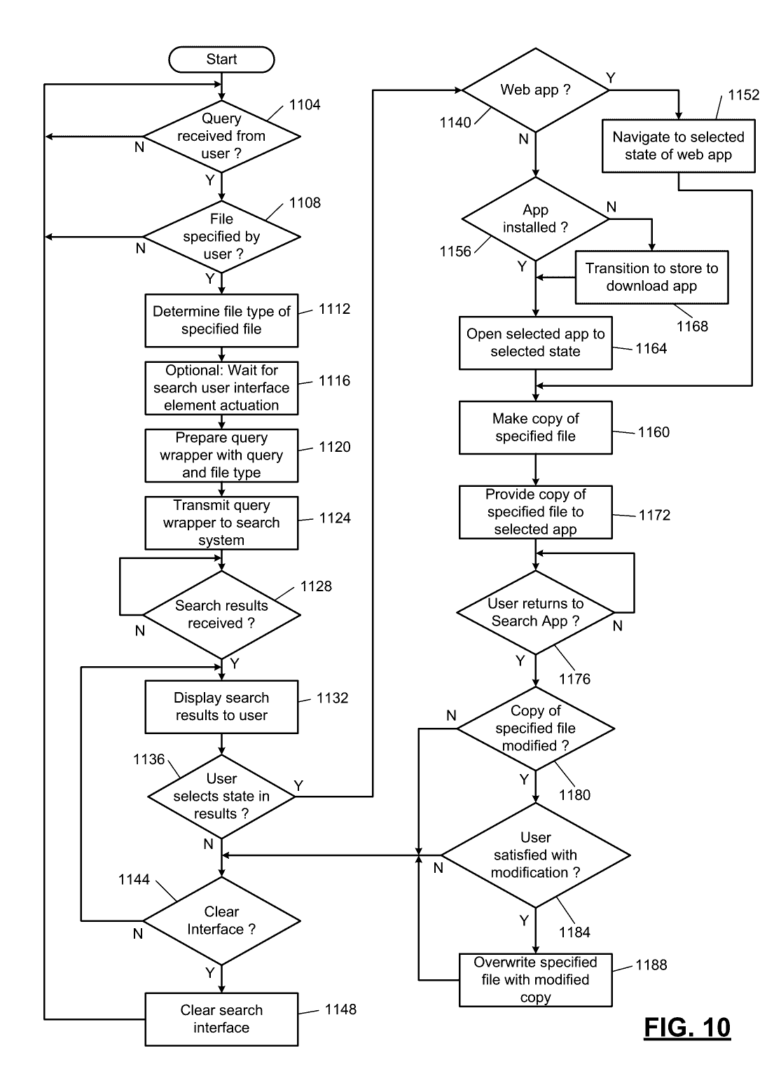

In FIG. 10, example operation of a search app starts when the app is first opened following a device restart or may start the first time the app is opened after being installed. Alternatively, the control of FIG. 10 may start whenever the user opens the search app after a period of not using the search app. At 1104, control determines whether a query has been received from a user. If so, control transfers to 1108; otherwise, control remains at 1104.

At 1108, if a file has been specified by the user, control transfers to 1112; otherwise, control returns to 1104. At 1112, control determines a file type of the specified file. The determined file type may be a MIME type or media type, or may simply be a file extension. The MIME type or media type may be determined based on the file extension, a review of the header of the file, and/or based on an analysis of the header and/or body of the file.

Control continues at 1116, where control may wait for the user to actuate a user interface element related to the search. Alternatively, control may immediately commission the search but wait to display results until the user has indicated their desire to search. At 1120, control prepares a query wrapper, such as described above. The query wrapper will generally include the query mentioned at 1104 and the file type determined at 1112.

At 1124, control transmits the query wrapper to a certain system. Control waits at 1128 until search results have been received from the search system and then transfers to 1132. At 1132, control displays the search results to the user. At 1136, control determines whether a user selects a state from the results. If so, control transfers to 1140; otherwise, control transfers to 1144. Selecting of the app state may be indicated by the user touching, tapping, or clicking an area in which one of the results is displayed. Alternatively, a specific area is designated for each result and only a selection of that particular area will indicate a user selection of one of the states. For example, an underlined hyperlink may be clicked by the user while the surrounding text images and other metadata may be inert.

At 1144, control determines whether to clear the user interface. If so, control transfers to 1148; otherwise, control returns to 1132. For example only, control may clear the interface after a period of disuse or after the search app has not had the focus (running as a background task) for more than a predetermined period of time. If the interface is not cleared, the search results continue to be displayed by 1132. A user may also indicate that the interface should be cleared. For example, there may be an icon recognizable as intent to clear, such as an “X”.

At 1148, control clears the search interface and returns to 1104. In some implementations, the user may desire to perform another action on the same file, and therefore the search interface clearing may be performed only on the query and not on the designated file. For example, a user interface gesture or element may indicate that the query should be cleared without clearing the specified file. Additionally or alternatively, there may be another user interface element that signals the user's desire to perform another action. Actuating this user interface element may signal that the specified file should be retained while the query should be changed. In such a circumstance, only the query is cleared before control returns to 1104. This allows a second (or third, etc.) operation to be performed on the same file.

At 1140, control determines whether the selected result corresponds to a web app. If so, control transfers to 1152; otherwise, control transfers to 1156. At 1152, control navigates to the selected state of the web app, which may simply be pointing to a specific URL (uniform resource locator) in a web browser. Control then continues at 1160.

At 1156, control determines whether the app (which is not a web app and is therefore assumed to be a native app) is installed. If so, control transfers to 1164; otherwise, control transfers to 1168. At 1168, control transitions to a digital distribution platform (app store) to download the app. Control continues at 1164. At 1164, control opens the selected app to the selected state. It may be possible to open the selected app to the selected state using a single call, such as an intent. In other implementations, the app may be opened to a default state, such as a home screen, and then navigation commands can be sent to the selected app to arrive at the selected state. Control then continues at 1160.

At 1160, control makes a copy of the specified file and, at 1172, control provides a copy of the specified file to the selected app. For a native app, the copy may be provided by simply passing a reference or pointer. For a web app, the specified file may be uploaded. Control continues at 1176, where if the user returns to the search app, control transfers to 1180; otherwise, control remains at 1176. While in 1176, the user is interacting with the selected app or performing some other action not related to the search app.

At 1180, the user has returned to the search app and control determines whether the copy of the specified file has been modified. If so, control transfers to 1184; otherwise, control transfers to 1144. At 1184, control determines whether the user is satisfied with the modification. If so, control transfers to 1188; otherwise, control transfers to 1144. Control may determine that the user is satisfied with the modification by an affirmative response from the user. In other implementations, the user's dissatisfaction with the modification may be indicated by having actuated a back button to return to the search app without performing a save or other function in the selected app.

At 1188, control has determined that the user was satisfied with the modification. Therefore, control overwrites the specified file with the modified copy and continues at 1144. In other implementations, the creation of a copy and the overwriting of the specified file may be omitted and the specified file itself may be provided to the selected app. Then, reversing of changes made by the selected app may be left to the selected app itself.

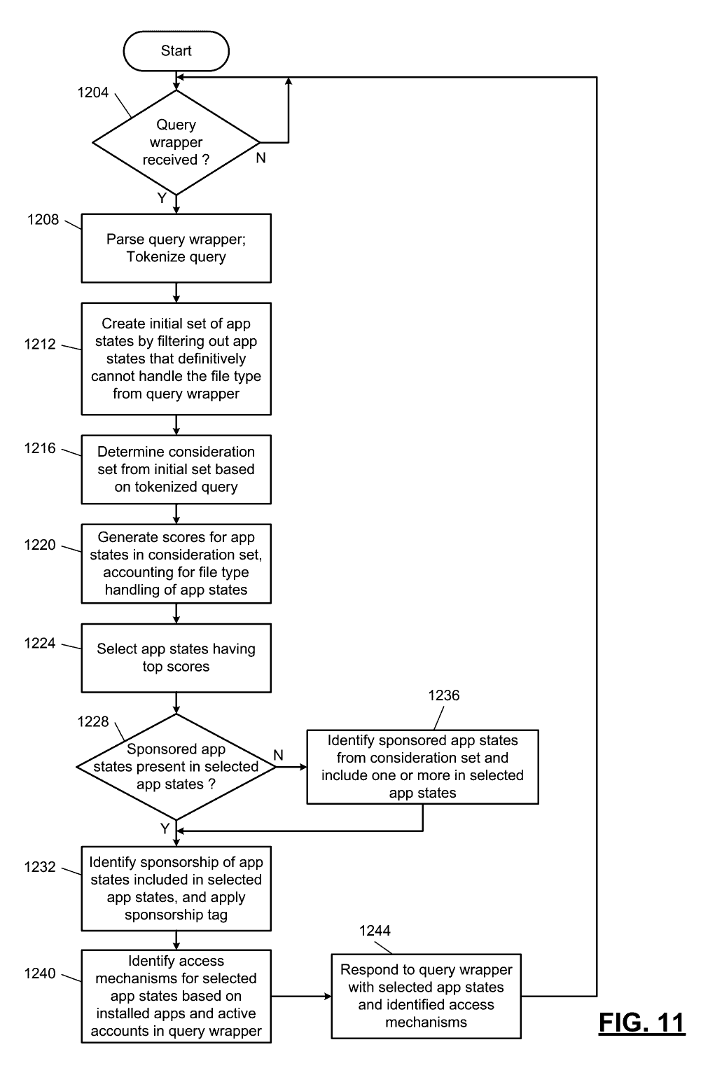

In FIG. 11, example control of a search module for a file-type-based search begins at 1204. If a query wrapper is received at 1204, control transfers to 1208; otherwise, control remains at 1204. At 1208, control parses the query wrapper, including tokenizing the query.

At 1212, control creates an initial set of candidate app states by filtering out app states that definitively cannot handle the file type specified by the query wrapper. Alternatively, the initial set may be created by filtering out all app states except for app states that definitively can handle the file type specified by the query wrapper. In these implementations, if there are no apps that can definitively handle the file type, the initial set may be expanded to include apps that might be able to handle the file type.

At 1216, control determines a consideration set from within the initial set based on the tokenized query. At 1220, control generates scores for each app state in the consideration set. The scores account for how confident the search system is that the corresponding app state can handle the specified file type. All other parameters being equal, an app state for which the confidence of handling of the file type is higher will receive a higher score.

At 1224, control selects those app states having the top scores in order to respond to the query. At 1228, control determines whether sponsor app states are present in the selected app states. If so, control transfers to 1232; otherwise, control transfers to 1236. At 1236, control identifies sponsored app states from the consideration set and includes one or more of those sponsored app states within the selected app states. If no sponsored app states appear in the consideration set, this may be an indication that no sponsored app states are relevant enough and therefore no sponsored app states will be included in the search results. Control continues at 1232.

At 1232, all app states within the selected app states that have some sponsorship are identified and a sponsorship tag may be applied. The sponsorship tag may indicate to the search app that the app state should receive visual emphasis, whether by altering font face, size, coloring, or position on the screen. At 1240, control identifies access mechanisms for the selected app states. The access mechanisms may be based on information about apps installed on the user device and accounts that are active in the user device. This information may have been provided in the query wrapper.

For an app state that only has a single access mechanism, that access mechanism will be provided. For an app that is installed, the provided access mechanism will navigate to the appropriate state. If the app is not installed, an access mechanism will be included that first downloads the app and then navigates to the selected state. If it is unclear whether the app is installed, both of these access mechanisms may be included.

As a backup, a web access mechanism may be included for any selected app state for which a web access mechanism exists. In this way, if the user is not able to or does not want to install or use an app, the functionality can still be accessed via the web edition of the app.

Control continues at 1244, by responding to the query wrapper with the selected app states and their corresponding access mechanisms. Control then returns to 1204. In various implementations, the user may specify a first search query and the file, and interact with one of the search results that are responsive to the first search query and the file type of the file to manipulate the file. The user may then specify a second search query (e.g., modify the first search query), and interact with one of the search results that are responsive to the second search query and the file type of the file to further manipulate the file. The user may interact with different ones of the search results to manipulate the file multiple times and, in some examples, in different ways (e.g., by performing multiple different functions with respect to the file within the corresponding application states).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. An apparatus comprising:
a user interface module configured to allow a user to identify a file and to enter a query;
a file type determination module configured to determine type data for the identified file, wherein the type data indicates a file type of the identified file;
a query wrapper construction module configured to create a query wrapper based on the type data and the entered query;
a network communication module configured to transmit the query wrapper to a search system and receive a result set from the search system, wherein the result set includes (i) an identification of a first app state of a first app and (ii) a first access mechanism for the first app state;
a result presentation module configured to present the result set to the user, including presenting a first user interface element corresponding to the first app state; and
an access module configured to, in response to actuation of the first user interface element by the user, (i) open the first app to the first app state according to the first access mechanism and (ii) provide the identified file to the first app state.

2. The apparatus of claim 1 wherein the type data includes one of (i) an Internet Assigned Numbers Authority media type and (ii) a MIME (Multipurpose Internet Mail Extensions) type.

3. The apparatus of claim 1 wherein the file type determination module is configured to determine type data for the identified file based on at least one of an extension of the identified file and a header region of the identified file.

4. The apparatus of claim 1 wherein the file type determination module is configured to set the type data for the identified file equal to an extension of the identified file.

5. The apparatus of claim 1 wherein the access module is configured to, in response to the first access mechanism being a web access mechanism, upload the identified file to a web server hosting the first app state.

6. The apparatus of claim 1 wherein the access module is configured to, in response to the first access mechanism being a native access mechanism, provide a location reference of the identified file to the first app state.

7. The apparatus of claim 1 further comprising a file management module configured to create a copy of the identified file prior to providing the identified file to the first app state.

8. The apparatus of claim 7 wherein the file management module is configured to overwrite the identified file with the copy in response to an indication by the user that a modification made to the identified file was unwanted.

9. The apparatus of claim 1 wherein:
the result set includes (i) an identification of a second app state of a second app and (ii) a second access mechanism for the second app state; and
the access module is configured to, subsequent to modification of the identified file by the first app state and in response to actuation of a second user interface element by the user, (i) open the second app to the second app state according to the second access mechanism and (ii) provide the modified identified file to the second app state.

10. The apparatus of claim 1 wherein:
the user interface module is configured to, subsequent to the user exiting from the first app state after modifying the identified file, allow the user to enter a second query;
the query wrapper construction module is configured to create a second query wrapper based on the type data and the second entered query;
the network communication module is configured to transmit the second query wrapper to the search system and receive a second result set from the search system, wherein the second result set includes (i) an identification of a second app state and (ii) a second access mechanism for the second app state, wherein the second app state is from one of the first app and a second app;
the result presentation module is configured to present the second result set to the user, including presenting a second user interface element corresponding to the second app state; and
the access module is configured to, in response to actuation of the second user interface element by the user, (i) open the one of the first app and the second app to the second app state according to the second access mechanism and (ii) provide the modified identified file to the second app state.

11. The apparatus of claim 1 further comprising an installed app data store that tracks apps installed on the apparatus, wherein the query wrapper construction module is configured to include information from the installed app data store in the query wrapper.

12. The apparatus of claim 1 further comprising an account data store that tracks active accounts registered with an operating system of the apparatus, wherein the query wrapper construction module is configured to include information from the account data store in the query wrapper.

13. A method of operating a device, the method comprising:
presenting a user interface to a user, wherein the user interface provides for identification of a file by the user and entering a query by the user;
determining type data for the identified file, wherein the type data indicates a file type of the identified file;
creating a query wrapper based on the type data and the entered query;
transmitting the query wrapper to a search system;
receiving a result set from the search system, wherein the result set includes (i) an identification of a first app state of a first app and (ii) a first access mechanism for the first app state;
presenting the result set to the user, including presenting a first user interface element corresponding to the first app state; and
in response to actuation of the first user interface element by the user, (i) opening the first app to the first app state according to the first access mechanism and (ii) providing the identified file to the first app state.

14. The method of claim 13 wherein the type data includes one of (i) an Internet Assigned Numbers Authority media type and (ii) a MIME (Multipurpose Internet Mail Extensions) type.

15. The method of claim 13 wherein the determining the type data is performed based on at least one of an extension of the identified file and a header region of the identified file.

16. The method of claim 13 wherein the determining the type data includes setting the type data based on an extension of a name of the identified file.

17. The method of claim 13 wherein the providing the identified file to the first app state includes, in response to the first access mechanism being a web access mechanism, uploading the identified file to a web server hosting the first app state.

18. The method of claim 13 wherein the providing the identified file to the first app state includes, in response to the first access mechanism being a native access mechanism, providing a location reference of the identified file to the first app state.

19. The method of claim 13 further comprising:
creating a copy of the identified file prior to providing the identified file to the first app state; and
overwriting the identified file with the copy in response to an indication by the user that a modification made to the identified file was unwanted.

20. The method of claim 13 wherein:
the result set includes (i) an identification of a second app state of a second app and (ii) a second access mechanism for the second app state; and
the method further comprises:
subsequent to modification of the identified file by the first app state, presenting a second user interface element; and
in response to actuation of the second user interface element by the user, (i) opening the second app to the second app state according to the second access mechanism and (ii) providing the modified identified file to the second app state.

21. The method of claim 13 further comprising:
subsequent to the user exiting from the first app state after modifying the identified file, allowing the user to enter a second query;
creating a second query wrapper based on the type data and the second entered query;
transmitting the second query wrapper to the search system;
receiving a second result set from the search system, wherein the second result set includes (i) an identification of a second app state and (ii) a second access mechanism for the second app state, wherein the second app state is from one of the first app and a second app;
presenting the second result set to the user, including presenting a second user interface element corresponding to the second app state; and
in response to actuation of the second user interface element by the user, (i) opening the one of the first app and the second app to the second app state according to the second access mechanism and (ii) providing the modified identified file to the second app state.

22. The method of claim 13 further comprising:
identifying apps installed on the device; and
identifying active accounts on the device,
wherein the query wrapper includes information based on the identified installed apps and the identified active accounts.

23. A non-transitory computer-readable medium storing instructions that perform the method of claim 13.
